(19) United States
(12) Patent Application Publication
(10) Pub. No.: US 2023/0094483 A1
(43) Pub. Date: Mar. 30, 2023

(54) PAD CONDITIONER WITH POLYMER BACKING PLATE

(71) Applicant: ENTEGRIS, INC., Billerica, MA (US)

(72) Inventors: Doruk YENER, Bedford, MA (US); Joseph SOUSA, Lakeville, MA (US); Elango Balu, North Reading, MA (US); Laundy Oeur, Lowell, MA (US); Ajoy ZUTSHI, Fremont, CA (US)

(21) Appl. No.: 17/951,429

(22) Filed: Sep. 23, 2022

Related U.S. Application Data
(60) Provisional application No. 63/249,888, filed on Sep. 29, 2021.

(51) Int. Cl. B24B 53/017; B24B 37/16; B24B 37/14

(52) U.S. Cl. CPC B24B 53/017; B24B 37/16; B24B 37/14; B33Y 80/00

(57) ABSTRACT

A chemical mechanical planarization (CMP) pad conditioner assembly includes a backing plate including at least one polymer and at least one additive. The at least one additive is present in an amount sufficient to result in a backing plate having at least one of a magnetic property, a color property, a structural property, or any combination thereof. The CMP pad conditioner assembly includes a plurality of segments including a ceramic substrate and a plurality of laser textured protrusions integral with the ceramic substrate. The plurality of laser textured protrusions is coated with a conformal diamond layer.

### CROSS-REFERENCE TO RELATED APPLICATIONS

This application claims the benefit under 35 USC 119 of U.S. Provisional Patent Application No. 63/249,888, filed Sep. 29, 2021, the disclosure of which is hereby incorporated herein by reference in its entirety.

### FIELD

This disclosure relates generally to equipment for manufacturing semiconductors. More particularly, this disclosure relates to a backing plate for a pad conditioner in chemical mechanical planarization (CMP).

### BACKGROUND

Chemical mechanical planarization or chemical mechanical polishing (CMP) can be part of the manufacturing process for semiconductor devices. During CMP, material is removed from a wafer substrate via a polishing pad and a polishing slurry. CMP can optionally include one or more chemical reagents. Over time, the polishing pad can become matted and filled with debris. A pad conditioner can be used to recondition the polishing pad.

### SUMMARY

In some embodiments, a chemical mechanical planarization (CMP) pad conditioner assembly includes a backing plate including at least one polymer and at least one additive. In some embodiments, the at least one additive is present in an amount sufficient to result in a backing plate having at least one of a magnetic property, a color property, a structural property, or any combination thereof. In some embodiments, the CMP pad conditioner assembly includes a plurality of segments including a ceramic substrate and a plurality of laser textured protrusions integral with the ceramic substrate. In some embodiments, the plurality of laser textured protrusions is coated with a conformal diamond layer.

In some embodiments, the at least one additive includes at least one of a metallic particulate filler, a pigment filler, a structural filler, or any combination thereof.

In some embodiments, the at least one additive includes a magnetic member embedded in the backing plate.

In some embodiments, the magnetic member is configured to secure the backing plate to a structure by a magnetic force.

In some embodiments, the pigment filler includes a heat-activated pigment filler.

In some embodiments, the heat-activated pigment filler is configured to result in a color change at a predetermined temperature.

In some embodiments, the backing plate is an additive manufactured backing plate.

In some embodiments, the additive manufactured backing plate has a monolithic structure of unitary construction.

In some embodiments, the polymer includes at least one of acrylonitrile butadiene styrene (ABS); polycarbonate; polyester; nylon; polyvinyl chloride (PVC); polypropylene (PP); polyethylene terephthalate (PET); polyether ether ketone (PEEK); polyether ketone (PEK); polytetrafluoroethylene (PTFE); or any combination thereof.

In some embodiments, a chemical mechanical planarization (CMP) pad conditioner assembly includes an additive manufactured backing plate including at least one polymer and at least one additive. In some embodiments, the at least one additive is present in an amount sufficient to result in a backing plate having at least one of a magnetic property, a color property, a structural property, or any combination thereof. In some embodiments, the CMP pad conditioner assembly includes a plurality of segments including a ceramic substrate and a plurality of laser textured protrusions integral with the ceramic substrate. In some embodiments, the plurality of laser textured protrusions is coated with a conformal diamond layer.

In some embodiments, the at least one additive includes at least one of a metallic particulate filler, a pigment filler, a structural filler, or any combination thereof.

In some embodiments, the at least one additive includes a magnetic member embedded in the backing plate.

In some embodiments, the magnetic member is configured to secure the backing plate to a structure by a magnetic force.

In some embodiments, the pigment filler includes a heat-activated pigment filler.

In some embodiments, the heat-activated pigment filler is configured to result in a color change at a predetermined temperature.

In some embodiments, the backing plate is 3D-printed backing plate.

In some embodiments, the backing plate has a monolithic structure of unitary construction.

In some embodiments, the polymer includes at least one of acrylonitrile butadiene styrene (ABS); polycarbonate; polyester; nylon; polyvinyl chloride (PVC); polypropylene (PP); polyethylene terephthalate (PET); polyether ether ketone (PEEK); polyether ketone (PEK); polytetrafluoroethylene (PTFE); or any combination thereof.

In some embodiments, the backing plate does not include seams, braze joints, and weld joints.

In some embodiments, the backing plate includes one or more polymer layers.

In some embodiments, a chemical mechanical planarization (CMP) pad conditioner assembly includes a backing plate. In some embodiments, the backing plate includes a first face and a second face. In some embodiments, the first face includes a plurality of mounting locations. In some embodiments, the plurality of mounting locations include a textured surface configured to promote adhesion. In some embodiments, an adhesive is applied to each of the plurality of mounting locations. In some embodiments, a plurality of segments is secured to the first face at the plurality of mounting locations by the adhesive. In some embodiments, each of the plurality of segments includes a ceramic substrate; and a plurality of laser textured protrusions integral with the ceramic substrate and protruding away from the first face. In some embodiments, the plurality of laser textured protrusions is coated with a conformal diamond layer.

In some embodiments, the backing plate comprises a polymer, and the backing plate is made from an additive manufacturing process. In some embodiments, the backing plate is injection molded. In some embodiments, the backing plate includes metallic particulate fillers.

In some embodiments, the backing plate is disc-shaped.

In some embodiments, the backing plate includes a first face and a second face opposite the first face. In some embodiments, the plurality of mounting locations is disposed on the first face.

In some embodiments, the plurality of mounting locations is recessed into the first face.

In some embodiments, an aperture is disposed in a center of the backing plate.

In some embodiments, the backing plate includes a first face and a second face opposite the first face. In some embodiments, a metallic member is embedded into the second face. In some embodiments, the metallic member is disposed at a location so that at least a portion of the metallic member overlaps a portion of one of the plurality of mounting locations.

In some embodiments, the backing plate includes a polymer. In some embodiments, the polymer includes a pigment filler.

In some embodiments, the backing plate includes a polymer. In some embodiments, the polymer includes acrylonitrile butadiene styrene (ABS); polycarbonate; polyester; nylon (PA6, PA66, etc.); polyvinyl chloride (PVC); polypropylene (PP); polyethylene terephthalate (PET); polyether ether ketone (PEEK); polyether ketone (PEK); polytetrafluoroethylene (PTFE); or any combination thereof.

In some embodiments, a backing plate for a chemical mechanical planarization (CMP) pad conditioner assembly includes a backing plate. In some embodiments, the backing plate includes a plurality of mounting locations. In some embodiments, each of the plurality of mounting locations is configured to receive a segment comprising a plurality of protrusions. In some embodiments, the plurality of mounting locations include a textured surface configured to promote adhesion of a respective segment. In some embodiments, the backing plate includes a polymer. In some embodiments, the backing plate includes at least 90% by weight of the polymer. In some embodiments, an adhesive is applied to each of the plurality of mounting locations. In some embodiments, a plurality of segments is secured to the plurality of mounting locations by the adhesive. In some embodiments, each of the plurality of segments includes a ceramic substrate; and a plurality of laser textured protrusions integral with the ceramic substrate and protruding away from the backing plate. In some embodiments, the plurality of laser textured protrusions is coated with a conformal diamond layer.

In some embodiments, the backing plate is made from an additive manufacturing process.

In some embodiments, the backing plate comprises one or more polymer layers.

In some embodiments, the backing plate is injection molded.

In some embodiments, the backing plate comprises one or more metallic layers surrounded by one or more polymer layers.

In some embodiments, the plurality of mounting locations are recessed into the first face.

In some embodiments, an aperture is disposed in a center of the backing plate.

In some embodiments, the backing plate includes a first face and a second face opposite the first face. In some embodiments, a metallic member is embedded into the second face.

In some embodiments, the metallic member is disposed at a location so that at least a portion of the metallic member overlaps a portion of one of the plurality of mounting locations.

In some embodiments, the polymer includes a pigment filler.

In some embodiments, the polymer includes acrylonitrile butadiene styrene (ABS); polycarbonate; polyester; nylon (PA6, PA66, etc.); polyvinyl chloride (PVC); polypropylene (PP); polyethylene terephthalate (PET); polyether ether ketone (PEEK); polyether ketone (PEK); polytetrafluoroethylene (PTFE); or any combination thereof.

In some embodiments, a backing plate for a chemical mechanical planarization (CMP) pad conditioner assembly includes a plurality of mounting locations. In some embodiments, each of the plurality of segments is configured to receive a segment comprising a plurality of protrusions. In some embodiments, the plurality of mounting locations include a textured surface configured to promote adhesion of a respective segment.

In some embodiments, the backing plate includes a polymer. In some embodiments, the backing plate is made from an additive manufacturing process. In some embodiments, the backing plate is injection molded. In some embodiments, the polymer includes metallic particulate fillers. In some embodiments, the backing plate includes a pigment filler.

In some embodiments, the backing plate is disc-shaped.

In some embodiments, the backing plate includes a first face and a second face opposite the first face. In some embodiments, the plurality of mounting locations are disposed on the first face.

In some embodiments, the plurality of mounting locations are recessed into the first face.

In some embodiments, the backing plate includes an aperture in a center of the backing plate.

In some embodiments, the backing plate includes a first face and a second face opposite the first face. In some embodiments, a metallic member is embedded into the second face.

In some embodiments, the metallic member is disposed at a location so that at least a portion of the metallic member overlaps a portion of one of the plurality of pad mounting locations.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a top view of a pad conditioner assembly, according to some embodiments.

FIG. 2 shows a side view of a portion of the pad conditioner assembly of FIG. 1, according to some embodiments.

FIG. 3 shows a side view of a portion of the pad conditioner assembly of FIG. 1, according to some embodiments.

Like reference numbers represent the same or similar parts throughout.

### DETAILED DESCRIPTION

During the microelectronic device fabrication process, multiple integrated circuits are formed upon the surface of substrate. Examples of substrates include silicon wafers, gallium arsenide wafers, and the like. Each integrated circuit consists of microelectronic devices electrically interconnected with conductive traces known as interconnects. Interconnects are patterned from conductive layers formed on the surface of the substrate. The ability to form stacked layers of interconnects has allowed for more complex microelectronic circuits to be implemented in and on relatively small surface areas of the substrate. With the number of microelectronic circuits increasing and becoming more complex, the number of layers of a substrate is increasing. Accordingly, planarity of the substrate surface becomes an important aspect in semiconductor manufacturing.

Chemical mechanical planarization (CMP) is a method of planarizing the surface of a layer of a substrate. CMP combines chemical etching and mechanical abrasion to remove material from the surface of the substrate. During the CMP process, the substrate is attached to the head of a polishing tool and is inverted such that the surface having the integrated circuit faces a polishing pad. A slurry containing abrasive particles and a chemical etchant is deposited onto the rotating polishing pad. The chemicals can soften or react with the exposed surface material on the substrate that is being planarized. The polishing pad is fixedly attached to a turntable or platen. The substrate is polished by placing the rotating substrate into contact with the polishing pad while the polishing pad is rotated on the platen. The surface of the integrated circuit-embedded surface of the substrate can be removed by the combined action of chemical softening of the exposed surface material and physical abrasion brought about by relative movement between the polishing pad, the slurry, and the substrate.

As portions of the substrate are removed by the polishing pad, a combination of slurry and debris tends to clog and glaze the surface of the polishing pad, such that over time, the polishing pad becomes less effective at removing material from the substrate. The surface of the polishing pad is cleaned or conditioned by a CMP pad conditioning assembly, which has an abrasive surface that engages the polishing pad surface. Known CMP pad conditioning assemblies can have an abrasive surface that includes protrusions, mesas, or cutting edges and these may be coated with hard coatings like cubic boron nitride, diamond grit, or polycrystalline diamond. The abrasive surface of the pad conditioning assembly can itself become worn thereby rendering it less effective over time for reconditioning the CMP polishing pad. During conditioning of the CMP polishing pad, the pad conditioning assembly abrades the CMP pad and opens new pores and a fresh pad surface for polishing.

The CMP process utilizes many consumables including the slurry and chemicals, the polishing pad, and the pad conditioning assembly. Replacing consumables can be time consuming and result in lost manufacturing yield and reduced wafer throughput. Some CMP processes require pad conditioning over the entire pad surface (no edge exclusion). Maintaining the co-planarity of a pad conditioning assembly with the polishing pad during this operation when the conditioning disk sweep recipe extends the pad conditioning assembly beyond the outer diameter of the polishing pad can be difficult and can result in damage or excess wear to the pad. For example, segmented conditioning disk designs can tilt once the conditioning disk extends beyond the outer diameter of the pad. This can result in non-uniform/excess pad wear at the perimeter of the pad and may even result in tearing of the pad.

One of the largest cost drivers is the backing plate. Today they are mostly made of passivated stainless steel. Cost and Productivity is an issue.

Embodiments provide polymer backing plates. In some embodiments, the polymer backing plates include a plurality of mounting locations for segments defined by a textured surface that promotes adhesion of the segments to the backing plates. In some embodiments, the backing plates can be manufactured by an additive manufacturing process such as, but not limited to, 3D printing and the like. In some embodiments, the backing plates can be manufactured by injection molding.

In some embodiments, the polymer backing plates include at least one polymer and at least one additive. In some embodiments, the at least one polymer includes any polymer suitable for additive manufacturing. For example, the at least one polymer may include or may be derived from any polymer material useful for additive manufacturing (e.g., a 3D-printable polymer material). As used herein, a polymer material may include any type of polymeric material, including, for example and without limitation, a monomer(s), an oligomer(s), a polymer(s), or any combination thereof. In some embodiments, the at least one polymer includes a thermoplastic polymer. In some embodiments, the at least one polymer includes at least one of acrylonitrile butadiene styrene (ABS); polycarbonate; polyester; nylon (PA6, PA66, etc.); polyvinyl chloride (PVC); polypropylene (PP); polyethylene terephthalate (PET); polyether ether ketone (PEEK); polyether ketone (PEK); polytetrafluoroethylene (PTFE); or any combination thereof. In some embodiments, the at least one polymer may include a thermoset polymer, optionally in combination with at least one thermoplastic polymer.

In some embodiments, the at least one additive may be included to result in a backing plate having at least one of a magnetic property, a color property, a structural property, or any combination thereof. In some embodiments, the at least one additive includes at least one of the following: magnetic metal additives such as, but not limited to, ferritic and martensitic stainless steel, galvanized steel, combinations thereof, or the like; heat sensitive dyes; inorganic fillers such as, but not limited to, ceramic powders, ceramic fibers, glass fibers, graphite, graphene, carbon based powders, carbon based fibers, combinations thereof, or the like; suitable combinations thereof, or the like.

In some embodiments, the at least one additive is present in an amount sufficient to result in the backing plate having at least one of the magnetic property, the color property, the structural property, or any combination thereof.

In some embodiments, the filler can be present in an amount of 5 wt. % to 60 wt. % based on a total weight of the backing plate. For example, in some embodiments, the filler can be present in amount of at least 5%, at least 10%, at least 15%, at least 20%, at least 25%, at least 30%, at least 35%, at least 40%, at least 45%, at least 50%, at least 55%, no greater than 55%, no greater than 50%, no greater than 45%, no greater than 40%, no greater than 35%, no greater than 30%, no greater than 25%, no greater than 20%, no greater than 15%, no greater than 10%, greater than 5% to 60%, greater than 10% to 60%, greater than 15% to 60%, greater than 20% to 60%, greater than 25% to 60%, greater than 30% to 60%, greater than 35% to 60%, greater than 40% to 60%, greater than 45% to 60%, greater than 50% to 60%, greater than 55% to 60%, and/or any range or subrange therebetween, by weight of the filler based on the total weight of the backing plate.

In some embodiments, the polymer can be present in an amount of 40 wt. % to 95 wt. % based on a total weight of the backing plate. For example, in some embodiments, the polymer can be present in an amount of at least 40%, at least 45%, at least 50%, at least 55%, at least 60%, at least 65%, at least 70%, at least 75%, at least 80%, at least 85%, at least 90%, no greater than 90%, no greater than 85%, no greater than 80%, no greater than 75%, no greater than 70%, no greater than 65%, no greater than 60%, no greater than 55%, no greater than 50%, no greater than 45%, greater than 40% to 95%, greater than 45% to 95%, greater than 50% to 95%, greater than 55% to 95%, greater than 60% to 95%, greater than 65% to 95%, greater than 70% o 95%, greater than 75% to 95%, greater than 80% to 95%, greater than 85% to 95%, greater than 90% to 95%, and/or any range or subrange therebetween, by weight of the polymer based on the total weight of the backing plate.

In some embodiments, the filler and the polymer can be mixed in, for example, a twin screw extruder. In some embodiments, the mixture can be used to injection mold or additively manufacture the backing plate. In some embodiments, one or more features can be embossed onto the backing plate before the backing plate is fully cured and the features pressed and cured together in, for example, a hot press or the like.

In some embodiments, the polymer backing plates can include pigment fillers to, for example, color code a backing plate for a particular application. In some embodiments, the polymer backing plates can include one or more metallic fillers to provide additional structural integrity. In some embodiments, the polymer backing plates can include one or more heat activated fillers configured to provide a visual indication when the backing plate reaches a temperature defined by the selected filler. In some embodiments, the polymer backing plates can include one or more metallic particulate fillers.

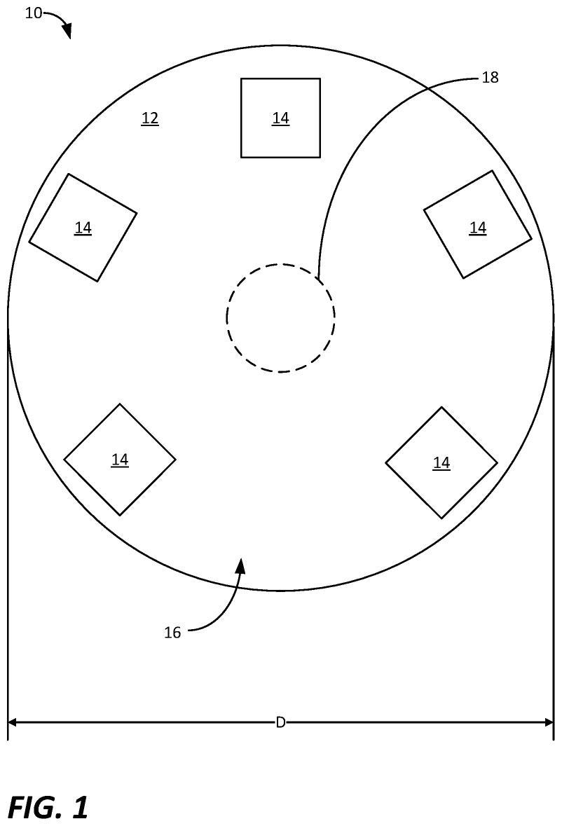

FIG. 1 shows a top view of a pad conditioner assembly 10, according to some embodiments.

In some embodiments, the pad conditioner assembly 10 includes a backing plate 12 and a plurality of segments 14. The backing plate 12 has a first face 16. The segments 14 are secured to the first face 16.

In some embodiments, the backing plate 12 has a disc-shape. In some embodiments, a shape of the backing plate 12 can be other than disc-shaped (e.g., square, rectangular, triangular, or the like).

In some embodiments in which the backing plate 12 is disc-shaped, the backing plate 12 can have a diameter D. In some embodiments, the diameter D can be from 3 inches to 13 inches. In some embodiments, the diameter D can be from 3 inches to 12 inches. In some embodiments, the diameter D can be from 3 inches to 11 inches. In some embodiments, the diameter D can be from 3 inches to 10 inches. In some embodiments, the diameter D can be from 3 inches to 9 inches. In some embodiments, the diameter D can be from 3 inches to 8 inches. In some embodiments, the diameter D can be from 3 inches to 7 inches. In some embodiments, the diameter D can be from 3 inches to 6 inches. In some embodiments, the diameter D can be from 3 inches to 5 inches. In some embodiments, the diameter D can be from 3 inches to 4 inches. In some embodiments, the diameter D can be from 4 inches to 13 inches. In some embodiments, the diameter D can be from 5 inches to 13 inches. In some embodiments, the diameter D can be from 6 inches to 13 inches. In some embodiments, the diameter D can be from 7 inches to 13 inches. In some embodiments, the diameter D can be from 8 inches to 13 inches. In some embodiments, the diameter D can be from 9 inches to 13 inches. In some embodiments, the diameter D can be from 10 inches to 13 inches. In some embodiments, the diameter D can be from 11 inches to 13 inches. In some embodiments, the diameter D can be from 12 inches to 13 inches.

It is to be appreciated that the above ranges are examples and the actual diameter D can vary beyond the stated ranges in accordance with the present description. In some embodiments in which the shape of the backing plate 12 is other than disc-shaped, the diameter D can be representative of a major dimension of the backing plate 12.

In some embodiments, the backing plate 12 can be made of a polymer material. In some embodiments, the polymer material can include a mixture including a plurality of polymers. In some embodiments, the backing plate 12 can include at least 90% by weight of the polymer. In some embodiments, the backing plate 12 can include at least 90% by weight of polymers. For example, in some embodiments, the polymer material can be acrylonitrile butadiene styrene (ABS); polycarbonate; polyester; nylon (PA6, PA66, etc.); polyvinyl chloride (PVC); polypropylene (PP); polyethylene terephthalate (PET); polyether ether ketone (PEEK); polyether ketone (PEK); polytetrafluoroethylene (PTFE); or any combination thereof. In some embodiments, the backing plate 12 can be made of a material that is chemically compatible with the CMP process chemicals and slurry. In some embodiments, the backing plate 12 can be chemically passivated. In some embodiments, the polymer material may not need to be chemically passivated. In such embodiments, the backing plate 12 can be cheaper to manufacture than current backing plates requiring chemical passivation.

In some embodiments, the backing plate 12 can include one or more fillers along with the polymer. For example, in some embodiments, a pigment filler can be included. In such embodiments, different pigment fillers or colorant fillers can be used to identify a particular backing plate 12 for a particular application. Examples of pigment fillers include, without limitation, at least one of a colorant, a dye, a pigment, or any combination thereof. In some embodiments, the one or more fillers can include a structural filler. Examples of structural fillers include, without limitation, carbon block, glass fiber, and the like. In some embodiments, the structural filler can be a metallic material embedded within the polymer. The metallic particulate filler material can, for example, be used to provide additional structural integrity to the backing plate 12. In some embodiments, the one or more fillers can include a heat activated material (e.g., a heat-activated pigment) configured to provide a visual indication when the backing plate 12 reaches a temperature defined by the selected filler (e.g., to visually indicate overheating could be occurring). In some embodiments, the one or more fillers can include a magnetic filler. In some embodiments, the magnetic filler can include magnetite (Fe₃O₄), hematite (α-Fe₂O₃), maghemite (γy-Fe₂O₃), a spinel ferrite, lodestone, cobalt, nickel, rare earth, magnetic composites, or any combination thereof. In some embodiments, the rare earth is neodymium, gadolinium, sysprosium, samarium-cobalt, or neodymium-iron-boron. In other embodiments, the magnetic composite comprises a ceramic, ferrite, alnico magnet, or any combination thereof.

In some embodiments, the backing plate 12 can be produced by an additive manufacturing process. As a result, in some embodiments, the backing plate 12 can be a monolithic structure of unitary construction. In such a structure, in some embodiments, the backing plate 12 does not include seams, braze joints, weld joints, or any combination thereof. For example, in some embodiments, the backing plate 12 can be produced by 3D printing. In such embodiments, different layers of the 3D printed backing plate 12 can be formed of different materials (e.g., to include a metallic layer or the like). For example, in some embodiments the backing plate 12 can include one or more metallic layers surrounded by one or more polymer layers. In some embodiments, the layers of the 3D printed backing plate 12 can be formed of the same material.

In some embodiments, the backing plate 12 can be produced by injection molding.

In some embodiments, the backing plate 12 includes the plurality of segments 14. The plurality of segments 14 can be secured to the first face 16 with an adhesive. In some embodiments, suitable adhesives include, but are not limited to, epoxies, tape adhesives, any combination thereof, or the like.

In the illustrated embodiment, five of the segments 14 are shown. It is to be appreciated that the number of the segments 14 can vary. For example, in some embodiments, the number of segments 14 can be less than five. In some embodiments, the number of segments 14 can be greater than five. A number of segments 14 may be selected based on a particular application or the like.

In some embodiments, each of the segments 14 generally provides an abrasive region. The abrasive regions collectively contact a polishing pad used in CMP when reconditioning the polishing pad using the pad conditioner assembly 10. The abrasive region is generally defined by a plurality of contact surfaces.

The various features of the segments 14 can be configured depending upon the application of the polishing pad being reconditioned using the pad conditioner assembly 10. For example, at least one of a relative size of the segments 14; a number of segments 14; a feature density on the segments 14; a depth of the features on the segments 14; any combination thereof; or the like, can be selected based on the application of the polishing pad to be reconditioned.

In the illustrated embodiment, the segments 14 are generally square-shaped when viewed from the top view. As used herein, “generally square-shaped” means square-shaped subject to manufacturing tolerances or the like. That is, the length and the width of the segments 14 is substantially the same subject to manufacturing tolerances or the like. In some embodiments, the geometry of the segments 14 can be a shape other than square. The segments 14 can include rounded corners and chamfered edges to, for example, minimize an accumulation of material and to, for example, reduce scratching resulting from this accumulation. In some embodiments, the segments 14 can be rectangular or the like.

In some embodiments, the location of the segments 14 on the backing plate 12 can be varied. In some embodiments, the spacing can be selected so that an arc length between each of the segments 14 is the same or substantially the same. As used herein, substantially the same means the same subject to manufacturing tolerances or the like. In some embodiments, the spacing can be selected so that the arc length between the segments 14 is not the same. In some embodiments, the locations of the segments 14 can be selected so that vibration of the pad conditioner assembly 10 is reduced when in use.

In some embodiments, the backing plate 12 can include an aperture 18. In some embodiments, the aperture 18 can be in a center of the backing plate 12. The aperture 18 is illustrated in dashed lines because the aperture 18 is optional. The aperture 18 can be referred to as a finger hole. That is, the aperture 18 can be used to enable the pad conditioner assembly 10 to be handled by an operator. In some embodiments, the aperture 18 can be used to enable handling the pad conditioner assembly 10 by other equipment.

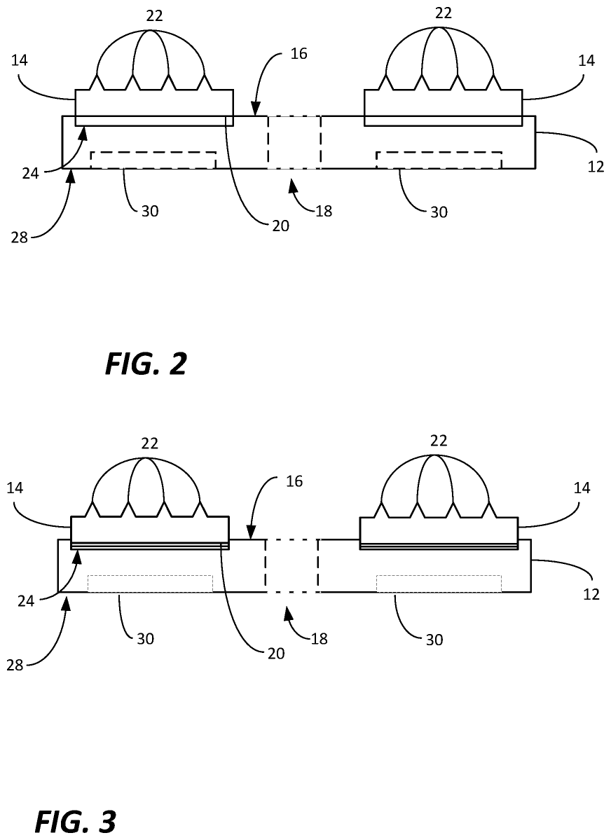

FIG. 2 shows a side view of the pad conditioner assembly 10 of FIG. 1, according to some embodiments.

In some embodiments, the segments 14 can include a core and one or more additional layers. In some embodiments, the core can be secured to the first face 16 via an adhesive 20. In some embodiments, the core can be a ceramic substrate. In some embodiments, the core can be, for example, a porous silicon carbide or the like. A surface layer is disposed on the core. In some embodiments, the surface layer can be a silicon carbide surface layer added to the core via, for example, a chemical vapor deposition (CVD) process. The surface layer can be etched (e.g., via a laser or the like) to create a plurality of surface features. The surface layer includes a hardened layer. The hardened layer can be, for example, a diamond coating that is added in a conformal layer to the surface layer via, for example, a CVD.

In some embodiments, the plurality of segments 14 provide the abrasion surface on the pad conditioner assembly 10. As such, when reconditioning a polishing pad for a CMP tool, the surface features contact the polishing pad. In some embodiments, the core and surface layer can collectively be referred to as a substrate.

Each of the segments 14 include a plurality of protrusions 22 protruding away from the first face 16.

In some embodiments, the protrusions 22 can be conical, frustoconical, a combination thereof, or the like. Other geometries for the protrusions 22 may be selected. In some embodiments, a first of the protrusions 22 can extend a first distance from the first face 16, while a second of the protrusions 22 can extend a second distance from the first face 16, the second distance being different from the first distance. In some embodiments, the first distance and the second distance can be the same.

In some embodiments, the backing plate 12 includes a textured surface 24. In some embodiments, the textured surface 24 can promote better adhesion of the segments 14 to the backing plate 12. In some embodiments, the segments 14 can be secured to the first face 16 at a plurality of mounting locations 26 defined by the textured surface 24 by the adhesive 20. In some embodiments, the adhesive 20 can include epoxies, tape adhesives, any combination thereof, or the like.

In some embodiments, the backing plate 12 includes a second face 28 opposite the first face 16. In some embodiments, the backing plate 12 can optionally include a member 30. The member 30 is illustrated in dashed lines to show that it is optional. In some embodiments, the member 30 is magnetic. In some embodiments, the member 30 can overlap at least partially with the segments 14. That is, in some embodiments, the member 30 can be in a same or similar location as the segments 14. In some embodiments, the member 30 is metallic and capable of being attracted by a magnet. The member 30 can be used, for example, to connect to equipment. The member 30 can be embedded into the backing plate 12. That is, in some embodiments, the member 30 can be recessed into the second face 28.

FIG. 3 shows a side view of the pad conditioner assembly 10 of FIG. 1, according to some embodiments.

In the illustrated embodiment, the backing plate 12 includes the textured surface 24 and the segments 14 are recessed below the first face 16. In some embodiments, the arrangement in FIG. 3 can be used in equipment in which an overall thickness of the pad conditioner assembly 10 is limited.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A chemical mechanical planarization (CMP) pad conditioner assembly, comprising:
a backing plate comprising at least one polymer and at least one additive,
wherein the at least one additive is present in an amount sufficient to result in a backing plate having at least one of a magnetic property, a color property, a structural property, or any combination thereof; and
a plurality of segments comprising a ceramic substrate and a plurality of laser textured protrusions integral with the ceramic substrate,
wherein the plurality of laser textured protrusions is coated with a conformal diamond layer.

2. The CMP pad conditioner assembly of claim 1, wherein the at least one additive comprises at least one of a metallic particulate filler, a pigment filler, a structural filler, or any combination thereof.

3. The CMP pad conditioner assembly of claim 1, wherein the at least one additive comprises a magnetic member embedded in the backing plate.

4. The CMP pad conditioner assembly of claim 3, wherein the magnetic member is configured to secure the backing plate to a structure by a magnetic force.

5. The CMP pad conditioner assembly of claim 1, wherein the at least one additive comprises a pigment filler, wherein the pigment filler comprises a heat-activated pigment filler.

6. The CMP pad conditioner assembly of claim 5, wherein the heat-activated pigment filler is configured to result in a color change at a predetermined temperature.

7. The CMP pad conditioner assembly of claim 1, wherein the backing plate is an additive manufactured backing plate.

8. The CMP pad conditioner assembly of claim 7, wherein the additive manufactured backing plate has a monolithic structure of unitary construction.

9. The CMP pad conditioner assembly of claim 1, wherein the polymer comprises at least one of acrylonitrile butadiene styrene (ABS); polycarbonate; polyester; nylon; polyvinyl chloride (PVC); polypropylene (PP); polyethylene terephthalate (PET); polyether ether ketone (PEEK); polyether ketone (PEK); polytetrafluoroethylene (PTFE); or any combination thereof.

10. A chemical mechanical planarization (CMP) pad conditioner assembly, comprising:
an additive manufactured backing plate comprising at least one polymer and at least one additive,
wherein the at least one additive is present in an amount sufficient to result in a backing plate having at least one of a magnetic property, a color property, a structural property, or any combination thereof; and
a plurality of segments comprising a ceramic substrate and a plurality of laser textured protrusions integral with the ceramic substrate,
wherein the plurality of laser textured protrusions is coated with a conformal diamond layer.

11. The CMP pad conditioner assembly of claim 10, wherein the at least one additive comprises at least one of a metallic particulate filler, a pigment filler, a structural filler, or any combination thereof.

12. The CMP pad conditioner assembly of claim 10, wherein the at least one additive comprises a magnetic member embedded in the backing plate.

13. The CMP pad conditioner assembly of claim 12, wherein the magnetic member is configured to secure the backing plate to a structure by a magnetic force.

14. The CMP pad conditioner assembly of claim 10, wherein the at least one additive comprises a pigment filler, wherein the pigment filler comprises a heat-activated pigment filler.

15. The CMP pad conditioner assembly of claim 14, wherein the heat-activated pigment filler is configured to result in a color change at a predetermined temperature.

16. The CMP pad conditioner assembly of claim 10, wherein the backing plate is 3D-printed backing plate.

17. The CMP pad conditioner assembly of claim 16, wherein the additive manufactured backing plate has a monolithic structure of unitary construction.

18. The CMP pad conditioner assembly of claim 10, wherein the polymer comprises at least one of acrylonitrile butadiene styrene (ABS); polycarbonate; polyester; nylon; polyvinyl chloride (PVC); polypropylene (PP); polyethylene terephthalate (PET); polyether ether ketone (PEEK); polyether ketone (PEK); polytetrafluoroethylene (PTFE); or any combination thereof.

19. The CMP pad conditioner assembly of claim 10, wherein the backing plate does not comprise seams, braze joints, and weld joints.

20. The CMP pad conditioner assembly of claim 10, wherein the backing plate comprises one or more polymer layers.
